(19) United States
(12) Patent Application Publication
(10) Pub. No.: US 2011/0301813 A1
(43) Pub. Date: Dec. 8, 2011

(54) CUSTOMIZABLE VIRTUAL LANE MARK DISPLAY

(75) Inventors: Bo Sun, Novi, MI (US); Daniel P. Tran, West Bloomfield, MI (US); Christopher A. Arms, Farmington Hills, MI (US); Carolina M. Giannotti, Riverview, MI (US); Justin McBride, West Bloomfield, MI (US); Nhi Van Pham, Dearborn, MI (US); Martin E. Nespolo, Rochester Hills, MI (US); Silviu Pala, Birmingham, MI (US); Michael Chachich, Wixom, MI (US)

(73) Assignee: DENSO INTERNATIONAL AMERICA, INC., Southfield, MI (US)

(21) Appl. No.: 12/795,131

(22) Filed: Jun. 7, 2010

(51) Int. Cl. G09G 5/00; B62D 15/02; H04N 7/18; G06F 7/00

(52) U.S. Cl. 701/41; 701/36; 345/9; 348/148; 348/E07.085

(57) ABSTRACT

A method of displaying virtual lane markings relative to a vehicle position within a roadway lane may entail reading vehicle data such as speed into a vehicle control module, determining if the vehicle data is above a particular threshold, switching a virtual lane display switch, determining weather conditions, and displaying virtual lane markings upon a vehicle windshield based upon a result of determining weather conditions. Detecting actual lane markings on one or both of a left side of the roadway lane and a right side of the roadway lane may be accomplished with a vehicle-mounted camera. Moreover, determining whether a steering wheel has rotated a predetermined number of degrees may further play a role in displaying the virtual lane markings on a windshield of the vehicle. From a driver viewing perspective through a windshield, virtual lane markings may be displayed on the windshield to overlay actual lane markings.

### FIELD

The present disclosure relates to a method of displaying a virtual lane marker on a windshield, such as in conjunction with a heads-up display.

### BACKGROUND

This section provides background information related to the present disclosure which is not necessarily prior art. Modern vehicles, such as automobiles, may be operated during periods of undesirable weather, such as during rainstorms or during periods of fog. Such periods of undesirable weather may decrease a driver's visibility of a road and road surroundings through a vehicle windshield. Still yet, visibility may be reduced during periods of nighttime driving. Because of such reduced driver visibility, a need exists to enhance a driver's knowledge of where a road lane exits.

### SUMMARY

This section provides a general summary of the disclosure, and is not a comprehensive disclosure of its full scope or all of its features. A method of displaying virtual lane markings, relative to a vehicle position within a vehicle roadway lane, upon a display area on an interior surface of a vehicle windshield may entail reading vehicle data, such as vehicle speed for example, into a vehicle control module and determining if the vehicle data is greater than a particular threshold. The method may also permit enabling a virtual lane display switch based upon the vehicle data achieving the particular threshold, switching the virtual lane display switch to a particular position (e.g. on, off or auto), and then displaying virtual lane markings on a vehicle windshield on each side of the roadway lane, relative to a driver's view through the windshield. Displaying virtual lane markings may further entail overlaying the virtual lane markings with actual lane markings, as viewed by a driver of the vehicle through the windshield. Before displaying virtual lane markings, the method may entail determining if actual lane markings exist or do not exist on the roadway lane.

Determining if actual lane markings exist on the roadway lane may entail reading an image of the roadway lane from a camera that is mounted inside of the vehicle and processing the images read with a corresponding control module. Displaying virtual lane markings may be accomplished with a holographic projector to project such virtual lane markings upon the projection area. Displaying virtual lane markings on the projection area of the vehicle windshield may entail displaying such on each side of the roadway lane, as viewed by a driver, and may further take into consideration whether a vehicle steering wheel has been rotated, or not rotated, a predetermined number of degrees. The method may also entail determining that actual lane marking are detectable by the camera and subsequently stopping the displaying of virtual lane markings.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top view of a vehicle depicting example locations of components of a virtual lane marking system in accordance with the present disclosure;

FIG. 2 is a side view of a vehicle depicting example locations of components of a virtual lane marking system in accordance with the present disclosure;

FIG. 3 is a flowchart depicting steps in a virtual lane marking system in accordance with the present disclosure;

FIG. 4 is a view from inside a vehicle in accordance with the present disclosure;

FIG. 5 is a view from inside a vehicle, including virtual lane markings, in accordance with the present disclosure;

FIG. 6 is a view from inside a vehicle, including virtual lane markings, in accordance with the present disclosure;

FIG. 7 is a top view of an intersection depicting a scenario for displaying virtual lane markings in accordance with the present disclosure; and

FIG. 8 is a view from inside a vehicle, including virtual lane markings overlaying actual lane markings, in accordance with the present disclosure.

Corresponding reference numerals indicate corresponding parts throughout the several views of the drawings.

### DETAILED DESCRIPTION

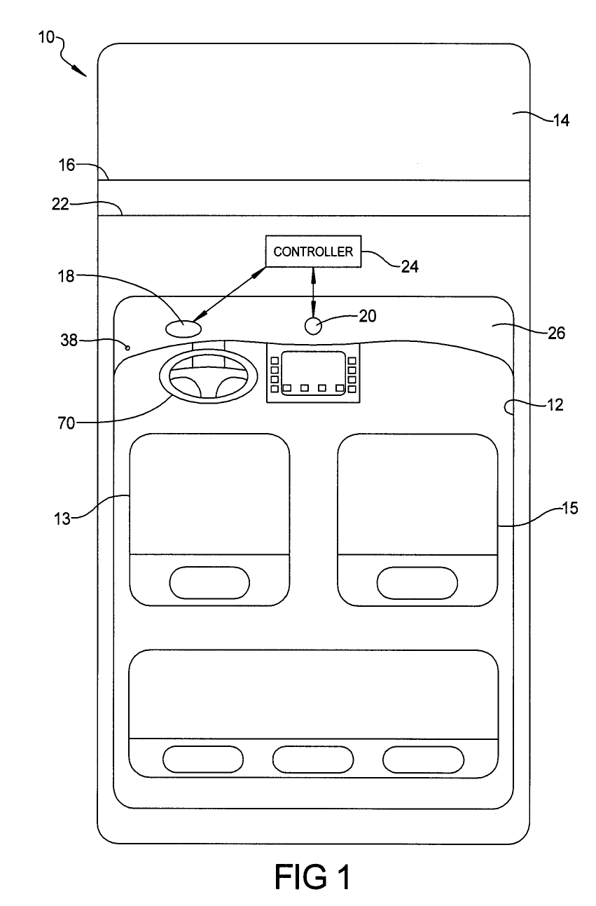

A virtual lane marking system and its method of operation in accordance with the present disclosure will be described with reference to FIGS. 1-8 of the accompanying drawings. FIG. 1 is a top view of a vehicle depicting components that may be utilized in performing a method of operation in accordance with the present disclosure. More specifically, FIG. 1 depicts a vehicle 10 having an engine compartment 12 and a passenger compartment 14. Engine compartment 12 and passenger compartment 14 may be divided by a firewall 16 to protect specific vehicle components within passenger compartment 14 from being subjected to heat and road debris to which engine compartment 12 is normally subjected. Thus, components such as a holographic projector 18 and a camera 20 may be located within passenger compartment 14, such as above or around rearview mirror 21. Holographic projector 18 and camera 20, which may be positioned to look forward of vehicle 10, may play a role in determining when to project holographic images onto windshield 22. A control module 24 may be located within passenger compartment 14, and as an example location, behind or under a dash 26 so that passengers within passenger compartment 12 are unable to see such a component when seated upon seats 13, 15. Holographic projector 18 may be adjustable so as to permit adjusting the holographic projector 18 and thereby adjust or move virtual images, such as virtual lane markings, to a position or positions desired by driver 30. Thus, projection area 28 may be large enough to accommodate a comfortable or desired projection area range desired by a multitude of drivers. Therefore, if desired, a driver 30 may adjust a position of holographic projector 18 which may then be retained for future use by a driver. Adjusting holographic projector 18 may be accomplished using motors or manual adjustment, or a combination of both.

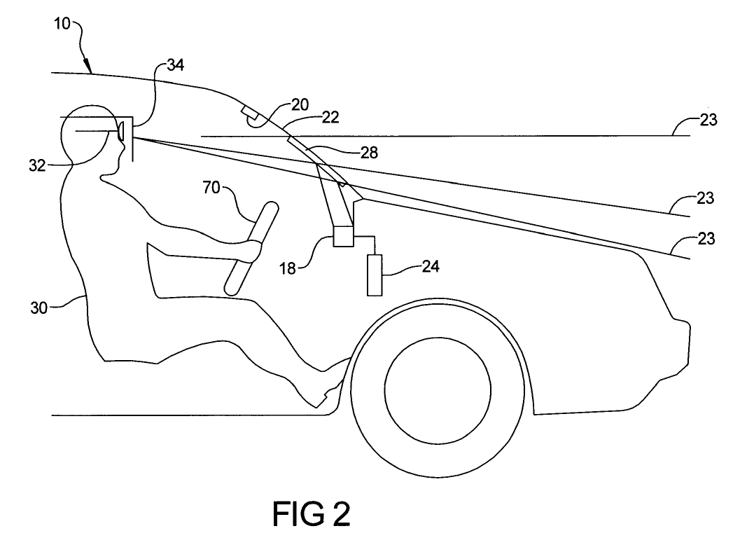

Turning to FIG. 2, a side view of vehicle 10 depicts an example location of camera 20, which may be directed forward of vehicle 10 to capture roadway images and then cooperate with holographic projector 18 to project images onto windshield 22, such as at holographic projection area 28. FIG. 2 also depicts a person 30, who may be a driver of vehicle 10. As depicted, person 30 may wear either eyeglasses 32 or a transparent shield 34, both of which are capable of receiving and displaying holographic images as an alternative to displaying holographic images upon windshield 22. Holographic images may be wirelessly transmitted to eyeglasses 32 or transparent shield 34, such as from control module 24 or from holographic projector 18.

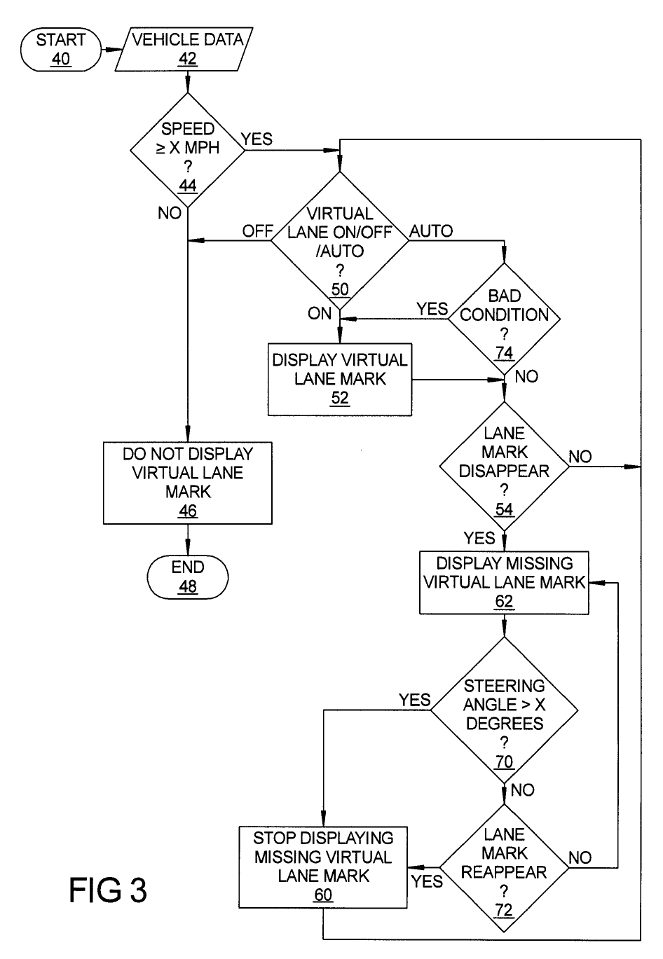

Turning now to FIG. 3, a flowchart pertaining to a method of displaying virtual lane markings will be presented. Subsequent to beginning at start block 40, logic of the flowchart of FIG. 3 proceeds to data block 42 where vehicle data is monitored and read into a memory, such as a memory in control module 24, for example. Vehicle data may include vehicle speed (e.g. mph, Km/h). Upon collecting and storing vehicle data at data block 42, logic of the flowchart of FIG. 3 proceeds to decision block 44 where a comparison of vehicle speed (e.g. real time or actual vehicle speed) is compared to a predetermined speed, which is depicted in the flowchart as “X” mph. If a result of the comparison made in decision block 44 is “no,” then the logic of the flowchart proceeds to block 46 where a command is made by controller 24 to display no virtual lane markings at projection area 28 of windshield 22. Logic of the flowchart may then end at block 48 and may then return to start again at block 40. Thus, virtual lane markings may only be projected onto windshield 22 when a speed of vehicle is above a predetermined speed. Virtual lane markings may also be projected in specific colors, such as to match a color of actual lane markings that are detected by camera 20, or virtual lane markings may be projected in a color different than a color of actual lane markings, such as in a contrast color to quickly and easily permit a driver to see such virtual lane markings.

Continuing with the flowchart, if the response at decision block 44 is “yes,” the logic proceeds to decision block 50 where an inquiry is made as to whether a virtual lane marking system is “on,” “off,” or in an automatic or “auto” mode. If the result of the inquiry at decision block 50 is “off,” the logic proceeds to block 46 where a command is made to display no virtual lane markings at projection area 28 of windshield 22. Logic of the flowchart may then end at block 48 and may then return to start block 40. However, if the result of the inquiry at decision block 50 is “on,” the logic proceeds to block 52 where a command by control module 24 is made to display virtual lane markings at projection area 28 of windshield 22. Decision block 50 may correspond to a switch 38 or button within an interior compartment of vehicle 10. Switch 38 may be located anywhere within passenger compartment 14, such as on dash 26 or as part of a cluster of interior buttons that are part of other vehicle controls. Logic of the flowchart may then proceed to decision block 54 where an inquiry is made if lane markings, such as lane markings 56 have disappeared. Lane markings that have disappeared are lane markings that are absent from a roadway upon which vehicle 10 is travelling, or lane markings that are otherwise undetectable by camera 20, such as lane markings that are so very faintly marked so as to not be discernable by camera 20, or lane markings that are covered, such as with snow. Regardless, lane markings that have disappeared as determined by the logic of the flowchart, are lane markings that are not detectable by camera 20. Essentially, detecting existing lane markings may be accomplished by optical detection or physical detection. Optical detection may be detecting existing lane markings with camera 20. Physical detection may be detecting lane markings from known map data and may provide awareness to control module 24 of lane markings that are ahead of vehicle 10 but that are not yet within a view of driver 30. If lane markings 56 have not disappeared, that is, if lane markings 56 are viewable and detectable by camera 20, then flowchart logic may again proceed to block 50. Logic of the flowchart may then return to decision block 50.

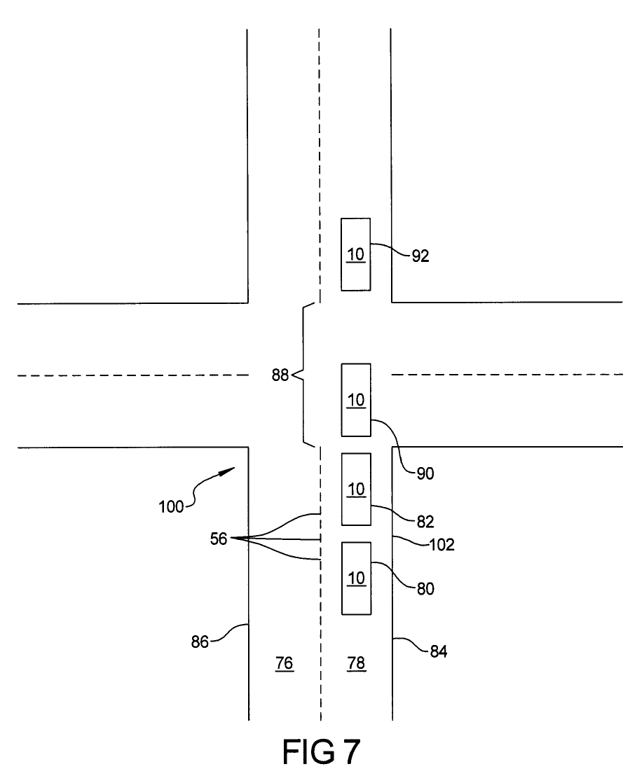

FIG. 7 will be used to further explain how block 54 and those blocks logically past or beyond block 54 may determine disappearance of actual, physical lane markings of a roadway upon which vehicle 10 is traveling. Along a straight portion of a roadway, center lane markings 56 may demark a dividing line between adjacent lanes 76, 78. As vehicle 10 moves from a location 80 to a location 82 along straight lane 78, camera 20 in conjunction with control module 24 may view and record images of various roadway lane markings 56, 84, 86. Moreover, control module 24 may store distances, such as an average distance between center lane markings 56 and right side lane markings 84, an average distance between center lane markings 56 and left side lane markings 86, and an average distance between right side lane markings 84 and left side lane markings 86. Such distances between various lane markings 56, 84, 86 and images of various lane markings 56, 84, 86 may be used when vehicle 10 moves into position 82. At position 82, camera 20 may detect the absence of lane markings 56 in center of roadway, such as at area 88, which may be an area in front of vehicle 10. Thus, when vehicle 10 is in position 82 and is moving into position 90, camera 20 is no longer able to view lane markings 56 between lanes 76, 78 because lane markings 56 no longer exist immediately in front of vehicle 10.

In one example, camera 20 may detect lane markings up to 12 feet (about 4 meters) in front of vehicle 10. Upon camera 20 not being able to discern lane markings 56 because lane markings 56 are absent from center of intersection 92 of lane 78, logic of the flowchart at block 54 may acknowledge that lane markings 56 have disappeared and then immediately display virtual lane markings in accordance with instruction at block 62. When displaying virtual lane markings upon projection area 28 of windshield 22 in accordance with block 62, memory resident with control module 24 may be utilized to store distances between lane markings 56, 84, 86 as vehicle 10 travels along lane 78. If vehicle 10 remains moving upon lane 78 with its steering wheel 70 turning less than a predetermined angle from a starting angle or starting position, then the logic may proceed to decision block 72 where an inquiry is made as to whether lane markings are detectable by camera 20.

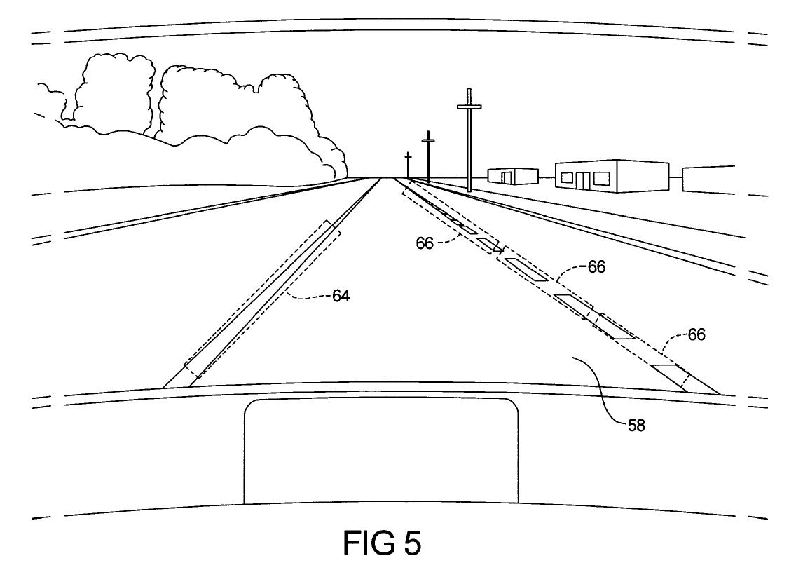

Camera 20 is a lane marking or road marking detector of lines or markings upon a roadway surface. If the result of the inquiry at decision block 72 is “no,” meaning that lane markings have not reappeared, then the logic proceeds (returns) to block 62. However, if lane markings have reappeared, then the logic proceeds from inquiry block 72 to block 60, where the logic instructs control module 24 to stop displaying virtual lane markings. That is, the logic instructs control module 24 to stop displaying virtual lane markings for missing or undetectable lane markings that are undetectable by camera 20. Virtual lane markings may be displayed on projection area 28 of windshield 22. Example lane markings may be those such as lane markings 66 depicted in FIG. 5. With virtual lane markings being projected upon windshield 22, vehicle 10 may move into position 90 of FIG. 7 and benefit from virtual lane markings until actual, physical lane markings once again appear on between lanes 76, 78 at position 92. As long as steering wheel 70 is not rotated a predetermined number of degrees from a starting angle or starting position, and actual lane markings are not-detectable by camera 20, virtual lane markings may continue to be displayed until actual, physical lane markings appear once again, at which time displaying of virtual lane markings is stopped, as indicated at block 60. However, if steering wheel 70 of vehicle 10 is turned at least a predetermined number of degrees, thus causing vehicle 10 to move from lane 78 and along a different path of travel, then logic of the flowchart at block 70 will pass to block 60 where holographic projector 18 will stop displaying missing virtual lane markings upon command by control module 24. logic of the flowchart will then return to block 50.

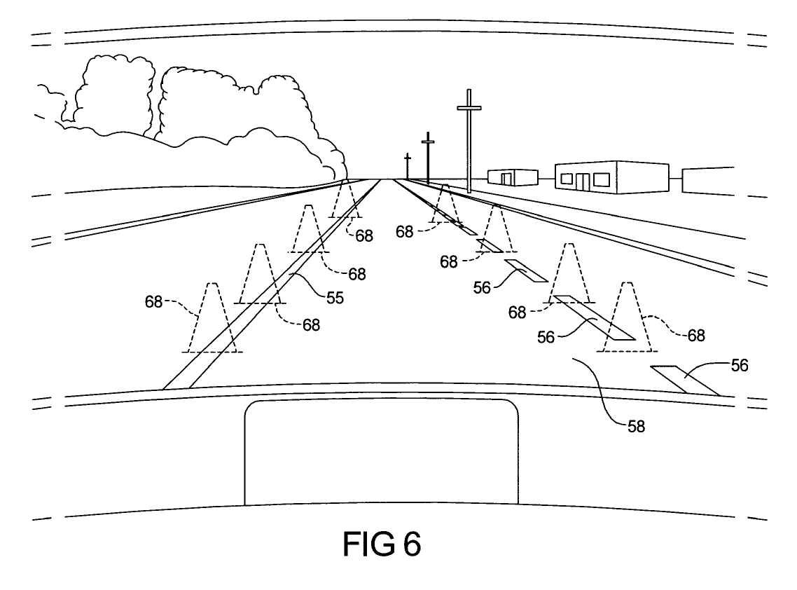

As an example of virtual lane markings that may be displayed upon projection area 28 of windshield 22 when actual, physical lane markings are determined to have disappeared from lane 78 (i.e. lane markings are non-detectable for some reason), FIG. 5 depicts a virtual continuous solid line 64 as a virtual lane marking and a series of virtual short solid lines 66. As an alternative, FIG. 6 depicts an example of virtual cones 68, instead of a virtual continuous solid line 64 or virtual short solid lines 66 that may be displayed upon projection area 28 of windshield 22 by holographic projector 18. Instead of displaying continuous solid lines and short solid lines as virtual lane markers on projection area 28, an array of user-selected virtual lane markers is possible based upon user preferences. User preferences may include different colors or shapes of virtual lane markings.

Decision block 50 offers yet a third option of automatic or “auto” in addition to “on” and “off,” introduced above. “Auto” may be a position of switch 38 that permits operation of holographic projector 18 in accordance with weather conditions, for example, which may be read into block 42 as vehicle data. In such a scenario, weather data may be read into memory of control module 24 via satellite radio or other source of weather. Bad weather may simply be a forecast for rain, a determination or forecast of a wet road by a moisture sensor on an exterior position of vehicle 10, or detection or forecast of snow or fog, as examples, or a current, real-time weather event of rain, snow or fog. Thus, if switch 38 is in a position that indicates “auto,” logic of the flowchart proceeds to decision block 74, and if an inquiry into weather conditions determine that whether conditions are “bad,” which may be weather conditions that make accurate viewing of actual, physical lane markings 56 by camera 20 impossible or incomplete, logic of the flowchart may proceed to block 52, which causes virtual lane markers 64, 66 to be displayed on projection area 28, as previously discussed. However, if weather conditions are determined not to be “bad,” then logic proceeds to decision block 54 which inquires whether actual, physical lane markings 56 have disappeared, which means that camera 20 can not recognize or detect any actual, physical lane markings on a roadway surface. From decision block 54, logic of the flowchart may proceed as previously presented.

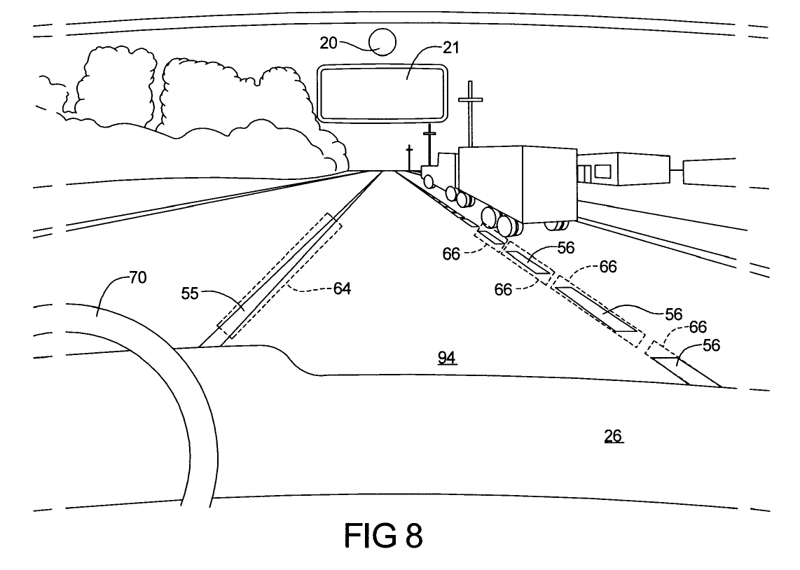

FIG. 8 depicts an active traffic scenario in which the logic of the flowchart in invoked. Continuing, while vehicle 10 is traveling upon a roadway 94, holographic projector 18 may display virtual lane markers 64, 66 on top of existing lane markers that are visible to a vehicle driver within vehicle 10. That is, virtual lane markings 64, 66 may be overlaid on existing lane markings. In such a scenario, switch 38 may be turned to “on” to ensure that virtual lane markings are displayed upon actual lane markings.

Stated slightly differently, a method of displaying virtual lane markings relative to a vehicle position within a roadway lane may entail reading vehicle data into vehicle control module 24. Vehicle data may be a vehicle speed, for example. The method may also entail determining if the vehicle data is great than a particular threshold, such as greater than a particular speed. The method may also entail enabling (e.g. providing power to) a virtual lane display switch 38 based upon the vehicle data and subsequently switching the virtual lane display switch 38 (e.g. on, off or auto). The method may also entail displaying virtual lane markings 64, 66, 68 on a vehicle windshield 22 such that virtual lane markings appear on each side of the roadway lane 58, when viewed by driver 30 looking through windshield 22 as depicted with driver sightlines 23 (FIG. 2). However, before any displaying of virtual lane markings, the method may entail determining if actual lane markings 56 exist or do not exist along roadway lane 58. As part of a method of displaying virtual lane markings, the process of determining if actual lane markings exist on roadway lane 58 may entail reading images of the roadway lane from a camera 20. Displaying virtual lane markings 64, 66, 68 may entail overlaying virtual lane markings 64, 66, 68 with actual lane markings 55, 56.

The method of displaying virtual lane markings 64, 66, 68 on vehicle windshield 22 so that virtual lane markings 64, 66, 68 appear on each side of roadway lane 58 may further entail determining whether steering wheel 70 has rotated or has not rotated through a certain number of degrees. That is, if steering wheel 70 has rotated a predetermined number of degrees, the method may entail stopping displaying virtual lane markings 64, 66, 68; however, if the steering wheel 70 has not rotated a predetermined number of degrees, the method may entail continuing the displaying or overlaying of virtual lane markings 64, 66, 68. Still yet, while virtual lane markings 64, 66, 68 are being displayed, the method may entail determining that actual lane markings 55, 56 on roadway lane 58 are detectable by camera 20. Upon such detection by camera 20, the method may entail stopping displaying virtual lane markings 64, 66, 68.

In another variation, displaying virtual lane markings 64, 66, 68 to mark a projected path of vehicle 10 upon roadway lane 58 may entail reading vehicle data into vehicle control module 24, determining if the vehicle data is greater than a particular threshold, switching a virtual lane display switch (e.g. on, off or auto), and displaying virtual lane markings 64, 66, 68 on vehicle windshield 22 depending upon a response of determining if actual lane markings 55, 56 exist or do not exist on roadway lane 58. Determining if actual lane markings 55, 56 exist or do not exist on roadway lane 58 may be considered determining a status of actual lane markings 55, 56 on roadway lane 58. Determining a status of actual lane markings 55, 56 on roadway lane 58 may further entail determining if actual lane markings exist or do not exist: on a left side (note actual marking 55) of roadway lane 58 from a driver 30 perspective, on a right side of roadway lane 58 (note actual markings 56) from a driver 30 perspective, or on both sides of roadway lane 58. Determining the status may be accomplished by detecting such existence with a camera 20 mounted on or within vehicle 10 and directed in front of or to a side of vehicle 10. Upon detecting an absence of actual lane markings on a surface of roadway lane 58, the method may then invoke displaying virtual lane markers 64, 66, 68 on vehicle windshield 22 where the at least one of a left side lane marking(s) and a right side lane marking(s) are not detectable by camera 20. Displaying virtual lane markings 64, 66, 68 on windshield 22 of vehicle 10 are displayed such that they overlay the area viewable by a vehicle driver where actual roadway lane markings 55, 56 may have originally existed or would exist if the roadway were equipped with roadway lane markings. Control module 24 may control whether or not to display virtual lane markings 64, 66, 68 based upon whether or not a steering wheel 70 has been rotated a predetermined number of degrees, such as by driver 30. In one example, in the event that only a left side lane markings are detectable, then control module 24 and holographic projector 18 may display the missing right side lane markings by using a standard lane width as a measure. That is, a standard lane width of 12 feet (3.66 m) may be used as a scale for displaying the right side virtual lane markings on projection area 28 using holographic projector 18.

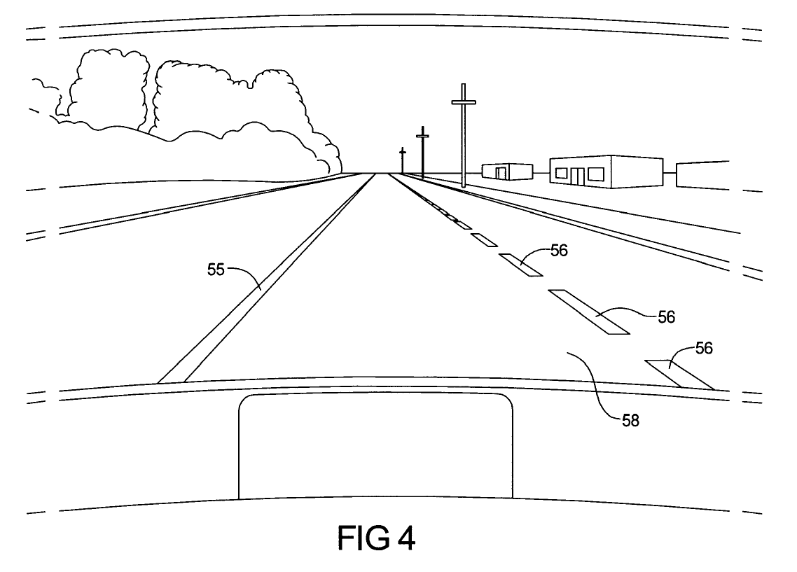

Still yet, a method of displaying virtual lane markings upon a roadway lane may entail reading vehicle data (e.g. mph, km/h) into vehicle control module 24, determining if the vehicle data is greater than a particular threshold (e.g. greater than a prescribed speed), switching a virtual lane display switch 38 to automatic mode, determining or assessing atmospheric weather conditions that may affect roadway lane 58, and displaying virtual lane markings 64, 66, 68 upon a projection area 28 of vehicle windshield 22 based upon a result of determining weather conditions. A vehicle-mounted camera 20, whether mounted interior to vehicle 10 or exterior to vehicle 10, may be used in determining if actual lane markings upon roadway lane 58 are detectable or not detectable on a left side of roadway lane 58, detectable or not detectable on a right side of the roadway lane 58, or are detectable or not detectable on a left side and a right side of roadway lane 58. Still yet, determining whether a steering wheel 70 has been rotated a predetermined number of degrees or determining whether a steering wheel 70 has not been rotated a predetermined number of degrees (or at all) may be accomplished and evaluated in displaying or in continuing to display virtual lane markings 64, 66, 68 on windshield 22 of vehicle 10. Displaying virtual lane markings 64, 66 on windshield 22 of vehicle 10 may actually be displayed in an overlay fashion, as depicted in FIG. 5 for example, relative to actual roadway lane markings 55, 56, as depicted in FIG. 4, that are viewable by vehicle driver 30 when driver 30 views roadway lane 58 through windshield 22.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method of displaying virtual lane markings on a vehicle windshield comprising:
reading vehicle data into a vehicle control module;
determining if the vehicle data is above a particular threshold;
enabling a virtual lane display switch based upon the vehicle data;
switching the virtual lane display switch; and
displaying virtual lane markings on the vehicle windshield on each side of a roadway lane relative to a driver's perspective.

2. The method of displaying virtual lane markings according to claim 1, further comprising:
determining if actual lane markings exist or do not exist on the roadway lane; and
displaying virtual lane markings on the vehicle windshield with a holographic projector.

3. The method of displaying virtual lane markings according to claim 1,
determining if weather conditions meet a threshold weather condition; and
from a perspective of a view of a vehicle driver through a windshield, displaying virtual lane markings on the windshield of the vehicle that overlay actual roadway lane markings upon determining the weather conditions meet a threshold weather condition.

4. The method of displaying virtual lane markings according to claim 2, wherein determining if actual lane markings exist on the roadway lane further comprises reading an image of the roadway lane from a camera.

5. The method of displaying virtual lane markings according to claim 3, wherein displaying virtual lane markings further comprises:
overlaying the actual lane markings with the virtual lane markings.

6. The method of displaying virtual lane markings according to claim 2, wherein displaying virtual lane markings on a vehicle windshield on each side of the roadway lane further comprises:
determining whether a steering wheel is not rotating.

7. The method of displaying virtual lane markings according to claim 2, wherein displaying virtual lane markings on a vehicle windshield on each side of the roadway lane further comprises:
determining whether a steering wheel has rotated a predetermined number of degrees.

8. The method of displaying virtual lane markings according to claim 4, further comprising:
determining that actual lane marking are detectable by the camera; and
stopping the displaying of virtual lane markings.

9. A method of displaying virtual lane markings relative to a vehicle position within a vehicle roadway lane comprising:
reading vehicle data into a vehicle control module;
determining if the vehicle data is above a particular threshold;
switching a virtual lane display switch; and
displaying virtual lane markings on a vehicle windshield depending upon a response of determining if actual lane markings exist or do not exist on the roadway lane.

10. The method of displaying virtual lane markings according to claim 9, further comprising:
determining a status of actual lane markings on the roadway lane.

11. The method of displaying virtual lane markings according to claim 9, wherein determining a status of actual lane markings on the roadway lane further comprises determining if actual lane markings exist or do not exist on the roadway lane.

12. The method of displaying virtual lane markings according to claim 9, wherein determining a status of actual lane markings on the roadway lane further comprises determining if actual lane markings exist on one of a left side of the roadway lane and a right side of the roadway lane.

13. The method of displaying virtual lane markings according to claim 9, further comprising:
determining that at least one of a left side and a right side lane markings are not detectable by a camera.

14. The method of displaying virtual lane markings according to claim 13, further comprising:
displaying virtual lane markers on a vehicle windshield where the at least one of a left side and a right side lane markings are not detectable by the camera.

15. The method of displaying virtual lane markings according to claim 14, further comprising:
displaying virtual lane markings on a windshield of the vehicle that overlay actual roadway lane markings of a roadway.

16. The method of displaying virtual lane markings according to claim 15, further comprising:
determining whether a steering wheel has rotated a predetermined number of degrees.

17. The method of displaying virtual lane markings according to claim 16, further comprising:
displaying the virtual lane markings on a windshield of the vehicle in accordance with the predetermined number of degrees that the steering wheel has been rotated.

18. A method of displaying virtual lane markings relative to a vehicle position within a roadway lane comprising:
reading vehicle data into a vehicle control module;
determining if the vehicle data is above a particular threshold;
switching a virtual lane display switch to automatic mode;
determining weather conditions; and
displaying virtual lane markings upon determining weather conditions.

19. The method of displaying virtual lane markings according to claim 18, further comprising:
determining if the weather conditions meet a threshold weather condition;
displaying virtual lane markings upon determining the weather conditions meet a threshold weather condition; and
using a vehicle-mounted camera, determining if actual lane markings upon the roadway lane are detectable on one or both of a left side of the roadway lane and a right side of the roadway lane.

20. The method of displaying virtual lane markings according to claim 19, further comprising:
determining whether a steering wheel has rotated a predetermined number of degrees;
displaying the virtual lane markings on a windshield of the vehicle in accordance with the predetermined number of degrees that the steering wheel has been rotated; and
from a perspective of a view of a vehicle driver through a windshield, displaying virtual lane markings on the windshield of the vehicle that overlay actual roadway lane markings.
